(19) United States
(12) Patent Application Publication
(10) Pub. No.: US 2001/0047275 A1
(43) Pub. Date: Nov. 29, 2001

(54) Authentication system

(76) Inventor: Michael S. Terretta, New Canaan, CT (US)

Correspondence Address: Basam E. Nabulsi, 113 Charter Oak Drive, Wilton, CT, 06897, US

(21) Appl. No.: 09/817,079

(22) Filed: Mar. 26, 2001

Related U.S. Application Data
(60) Provisional application No. 60/192,166, filed on Mar. 27, 2000.

(51) Int. Cl. G06F 17/60

(52) U.S. Cl. 705/1

(57) ABSTRACT

A system/method for facilitating registration and delivery of authenticated content across a computer network is disclosed herein. The disclosed system/method is particularly advantageous for applications in which it is desirable to rapidly and reliably register users and to authenticate content requests by users in a scalable manner. In preferred embodiments of the disclosed method/system, registration information is only stored in associated databases upon completion of the registration form by a prospective user, and the proposed payment mode is verified as part of the registration process. The disclosed system also ensures that a registered user does not simultaneously receive multiple content files by monitoring and checking the status of each such registered user before delivering content thereto.

### BACKGROUND

Cross Reference to Related Applications

The present application claims the benefit of a commonly assigned, copending provisional patent application entitled “Improved System for Providing Pay-Per-View Programming,” filed on Mar. 27, 2000 and assigned Serial No. 60/192,166, the contents of which are hereby incorporated by reference in their entirety.

1. Technical Field

The present disclosure relates to a system/method for facilitating registration and delivery of authenticated content across a computer network, and more particularly to a system/method for rapidly and reliably registering users and authenticating content requests by users in a scalable manner.

2. Background of Related Art

Techniques for registering individuals for a variety of purposes are well known. Thus, for example, individuals routinely register for goods and services by manually completing registration cards/questionnaires. Information collected through such registration processes may be retained in hard copy format and/or may be retained in computerized databases. Data entry systems for manually collected registration information include manual keypunching, scanning of information and the like. Confirmation/verification and updating of registration data may then be undertaken, as needed, by reviewing manual files and/or computerized look-up systems that access information-containing databases.

With the advent of widely accessible computer networks, e.g., the Internet and the World Wide Web, increased opportunities and applications utilizing on-line registration and real-time user authentication/verification have arisen. In typical on-line registration systems, users are required to provide relevant registration information to complete an on-line registration form. Generally, certain data fields are required, whereas other data fields may be optional. Typically collected information includes name, address, e-mail address, demographic data, and the like. Depending on the nature of the site for which registration is being undertaken, it may be necessary/desirable to solicit payment/credit-related information, e.g., credit card information, to secure payment for goods/services to be acquired by the registrant.

Data collected in on-line registration processes is typically stored in appropriate database systems, and is accessed on an as-needed basis in connection with a registrant's on-line activities. Thus, a single registration is generally required by a user to facilitate future uses of and visits to the on-line site. To confirm the identity of the individual utilizing the on-line site with respect to future visits to the site, a user name/password authentication system is typically employed. Users are often permitted to select a user name and password for entry into the associated database, thereby facilitating each user's interaction with the site.

Upon subsequent visits to the site, the user is generally required to transmit his/her user name and password. Such information is typically checked against information stored within the associated database and, provided a match exists, the system determines that the user is in fact a registered user. At such point, the user is generally permitted to utilize the on-line site, as appropriate, and to acquire goods/services. The purchase process may, however, require additional verification/authentication and/or data entry.

Despite the widespread use of conventional registration/authentication systems and techniques, a need remains for an authentication that rapidly and reliably registers and authenticates a registrant upon subsequent visits. Moreover, for on-line sites that experience significant peak visitor flows, e.g., in connection with live/taped live events, registration/authentication systems and processes must be particularly rapid to ensure that all desired users are given access to the desired content.

### SUMMARY OF THE DISCLOSURE

The present disclosure provides a system/method for facilitating registration and delivery of authenticated content across a computer network, and more particularly a system/method for rapidly and reliably registering users and authenticating content requests by users in a scalable manner.

In a preferred embodiment, the present disclosure provides an improved system for providing pay-per-view programming. As used herein, “pay-per-view” or PPV is not limited to programming that is provided in connection with monetary payment. Rather, it is contemplated that a range of value(s) or consideration may be received in connection with the provision of “PPV” programming hereunder, e.g., registration with a programming provider or the like. PPV also encompasses “authenticated viewing” in general, i.e., systems wherein user access to content is subject to a pre-authentication procedure and/or verification.

The attached FIG. 1 schematically depicts an improved system for providing PPV programming according to the present disclosure. Of note, the proprietary PPV “wizard” component depicted in FIG. 1 comprises a series of interfaces designed to increase a user's accuracy in self-reported data, and validates the supplied data against a plurality of databases. The user signs up and supplies payment information to the RACS (redundant array of commerce servers). Such payment information is automatically checked for approval by a credit bureau.

Upon receipt of an appropriate approval from the credit bureau, the sign-up wizard automatically updates the information contained in the commerce database to reflect the new/updated user information. In addition, the sign-up wizard updates the sign-up information in the LDAP (lightweight directory access protocol) database. The LDAP database translates the LDAP information into SQL (structural query language) statements and updates the membership/registration information in the SQL database. The SQL database in turn updates the membership/registration information in the RAID (redundant array of inexpensive disks) appliance.

Thus, the sign-up wizard automatically ensures that the user's creditworthiness has been confirmed and that all databases associated with the improved PPV system have received all new/updated registration/membership information immediately upon receipt of such information from the user/registrant/member.

The improved PPV programming system disclosed herein further includes a proprietary “live stream” authorization gateway component. Although this proprietary component is particularly advantageous in processing gateway authorizations with respect to “live streams,” the proprietary component also offers advantageous processing in connection with other data delivery modalities, e.g., on-demand content.

According to the proprietary “live stream” gateway disclosed herein, a user initially requests content from the private network disclosed in FIG. 1, e.g., a live stream. Such request is made by the user from his/her personal computer, personal digital assistant (PDA), set top box, and the like (collectively referred to as a “PC”). The request is received by the RAWS (redundant array of web servers). According to the present disclosure, a “plug-in” is typically provided that is operatively associated with the RAWS and which communicates through appropriate switches with the LDAP database. While it is currently contemplated that the algorithmic processing described herein may be advantageously achieved through a “plug-in,” the plug-in” may of course be integrated with the system, as will be readily apparent to persons skilled in the art.

The plug-in receives the user's request and queries the LDAP database as to whether the requested stream is protected, i.e., is access to the requested content limited to registered users. If the content is not protected, i.e., not restricted to access by registered users, the user will be given access without further clearance. The access parameters associated with content to be provided by the RAMS (redundant array of media servers) according to the present disclosure is stored within the LDAP database.

If the requested content is limited in its availability to registered users (members), the LDAP database so instructs the plug-in associated with the RAWS. In such case, the RAWS requests the user to provide appropriate registration/membership information, e.g., user name and password. Inasmuch as the sign-in wizard has previously established the creditworthiness of the registrant/member from the credit bureau, a further check as to creditworthiness is generally unnecessary.

The user enters his/her user name/password, etc., and forwards the information to the RAWS and its associated plug-in. The user name/password, etc. are passed through to the LDAP database for evaluation. In particular, the LDAP is requested to provide the user's entry information. The LDAP returns the user's entry information to the plug-in. The plug-in queries whether the user is already viewing a stream from RAMS. This inquiry is essential to ascertaining whether the user name/password may have been compromised and/or whether the user may be attempting to misuse his/her registration by allowing multiple individuals to view content based on a single registration. The proprietary system disclosed herein collects and retains information as to users currently viewing/receiving content from RAMS and is therefore able to ascertain the status of a user within the system. If the user is already receiving/viewing content from RAMS, the user is denied access to the newly requested content.

Conversely, if the user's account is not currently viewing/receiving content, the plug-in verifies that the password is correct and that the registrant is part of a group having clearance/access to the requested content. For example, content may be tiered and premiere content may only be available to certain registrants. Additional parameters may be used to differentiate available content for a specific user, e.g., age appropriateness, predetermined content restrictions, etc. If the individual requesting the content is part of the group entitled to access the requested content, the plug-in instructs the databases that the user is about to begin viewing the requested content, and informs the user that he/she has been authorized to receive the requested content. Streaming of the content from the RAMS begins immediately thereafter.

When the user discontinues receiving/viewing the requested content, i.e., the stream has ceased or the user has disconnected, the user's status is communicated from the RAWS through the plug-in to the LDAP database so that the user's account status can be updated to reflect that he/she is no longer receiving content. In this way, the proprietary system disclosed herein ensures that “one ticket, one seat” is achieved.

Additional features, aspects and benefits associated with the disclosed system/method will be apparent from the detailed description, FIGURE and claims that follow.

### BRIEF DESCRIPTION OF THE FIGURE(S)

To facilitate a full and complete understanding of the disclosure herein, reference is made to the attached FIGURE and accompanying description, in which:

FIG. 1 is a schematic depiction of a system/method according to the present disclosure.

### DETAILED DESCRIPTION OF PREFERRED EMBODIMENT(S)

A system/method for facilitating registration and delivery of authenticated content across a computer network is disclosed herein. The disclosed system/method is particularly advantageous for applications in which it is desirable to rapidly and reliably register users and to authenticate content requests by users in a scalable manner. The disclosed system/method is also beneficial in facilitating pay-per-view registrations and in providing/delivering pay-per-view programming. As noted hereinabove, “pay-per-view” or PPV is not limited to programming that is provided in connection with monetary payment. Rather, it is contemplated that a range of value(s) or consideration may be received in connection with the provision of “PPV” programming hereunder, e.g., registration with a programming provider or the like. PPV also encompasses “authenticated viewing” in general, i.e., systems wherein user access to content is subject to a pre-authentication procedure and/or verification.

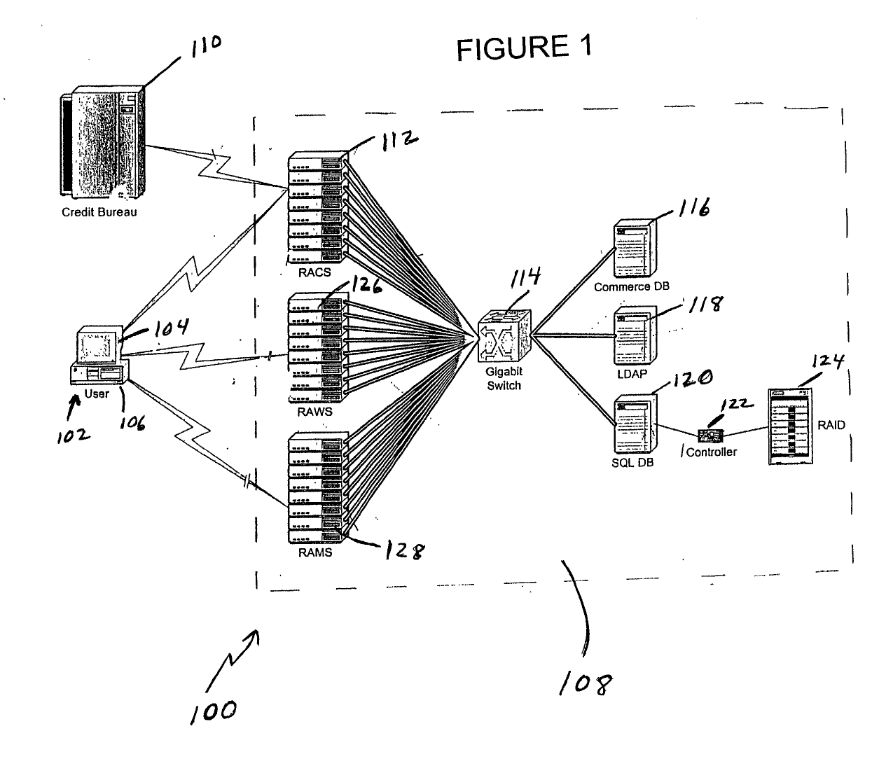

With reference to FIG. 1, a schematic depiction of an improved system 100 for facilitating PPV registration, and for facilitating rapid and reliable delivery of PPV programming, according to the present disclosure is provided. A user utilizes system 100 via a unit 102 that is in communication with the remainder of system 100 through a computerized network, e.g., via the Internet or World Wide Web. Unit 102 may be a personal computer having a monitor 104 and a central processing unit 106, as schematically depicted in FIG. 1, or may constitute an alternative apparatus for communicating as part of system 100, e.g., a cellular phone, set-top box and television console/screen, PDA, or the like, as will be apparent to persons of skill in the art.

The user communicates with a PPV subsystem 108 within system 100 via conventional network technology. Thus, unit 102 may communicate with PPV subsystem 108 via dial-up modem, cable, DSL or other land-line communication means. Communications between the user and PPV subsystem 108 may also utilize, in whole or in part, satellite-based and/or other non-terrestrial transmission technologies. In preferred embodiments of the present disclosure, users accessing PPV subsystem 108 have adequate bandwidth to accommodate file transmissions desired by the user without interruptive latency and/or packet loss. Bandwidth is of particular importance for embodiments involving broadband transmissions to and/or from users utilizing/accessing PPV subsystem 108.

In initially communicating with PPV subsystem 108, a user is generally required to provide registration information based on or in connection with an electronic registration form. The registration form may solicit a wide range of information/data, e.g., name, address, billing address, e-mail address, demographic information, computer-related information (e.g., preferred media player/format), and the like. Elements of the registration form may constitute required data entries, whereas other aspects of the registration form may constitute optional data entries. For systems/applications in which a user will be accessing/utilizing services upon visiting the site of interest, e.g., viewing PPV video content, retrieving restricted-rights content (e.g., musical performances, lectures and the like), etc., the user is generally required to provide information concerning the mode of payment, e.g., a credit card number and related information. PPV subsystem 108 advantageously automatically and electronically checks the user's credit with a credit bureau 110 based on the data provided to PPV subsystem 108.

The registration information provided to PPV subsystem 108 by the user is generally transmitted to RACS 112. RACS 112 constitutes a redundant array of commerce servers that provide significant scalability to PPV subsystem 108. It is RACS 112 that transmits the credit query to credit bureau 110 and receives the response therefrom. Of note, PPV subsystem 108 typically does not write information to any of the databases associated with PPV subsystem 108 until the user has completed the registration form. By limiting interaction with the associated databases until the user has completed the registration form/process, PPV subsystem 108 significantly increases its capability to handle peak registration volumes. Indeed, the non-recordation of incomplete registration information in the databases associated with PPV subsystem 108 advantageously enhances system scalability, reliability and speed.

Upon receipt of an appropriate approval from credit bureau 110, the sign-up wizard associated with PPV subsystem 108 automatically updates the information contained in commerce database 116 to reflect the new/updated user information. Such information is typically transmitted from RACS 112 through switch 114 to commerce database 116. In addition, the sign-up wizard associated with PPV subsystem 108 updates the sign-up information in LDAP (lightweight directory access protocol) database 118, again via switch 114. The LDAP database 118 translates the LDAP information into SQL (structural query language) statements and updates the membership/registration information in a SQL database 120 associated with PPV subsystem 108. The SQL database 120 in turn updates the membership/registration information in a RAID (redundant array of inexpensive disks) appliance 124 via a controller 122.

Thus, the sign-up wizard associated with PPV subsystem 108 automatically ensures that a user's creditworthiness has been confirmed and that all databases associated with PPV subsystem 108 have received all new/updated registration/membership information immediately upon receipt of such complete information from the user/registrant/member. In a preferred embodiment of the present disclosure, registration information is cached on the RAM drive of the server for LDAP database 118, thereby further enhancing the speed, reliability and scalability of PPV subsystem 108. Preferred caching technology for facilitating registration information caching on the LDAP database server is commercially available from SuperSpeed Software, Inc. (Sudbury, Mass.).

In a preferred embodiment of the present disclosure, PPV subsystem 108 further includes “live stream” authorization gateway technology. Although this functionality associated with PPV subsystem 108 is particularly advantageous in processing gateway authorizations with respect to “live streams,” such functionality also offers advantageous processing in connection with other data delivery modalities, e.g., delivery of on-demand content.

According to a preferred embodiment of the “live stream” gateway functionality disclosed herein, a registered user initially requests content, e.g., a live stream, from PPV subsystem 108, e.g., by submitting an electronic request across a computer network (e.g., the Internet or the World Wide Web) from unit 102. As noted hereinabove, such request may be made by the user from his/her personal computer, personal digital assistant (PDA), set top box, and the like. The user request is generally received by RAWS 126 (redundant array of web servers) associated with PPV subsystem 108. RAWS 126 constitutes a plurality of parallel web servers that enhance reliability, speed and scalability of PPV subsystem 108.

According to a preferred embodiment of the present disclosure, a “plug-in” is typically provided that is operatively associated with RAWS 126 and which communicates through switch(es) 114 with LDAP database 118. While it is currently contemplated that the algorithmic processing associated with the live stream gateway may be advantageously achieved through such “plug-in,” the functionality associated with such plug-in may be integrated with a component of PPV subsystem 108, as will be readily apparent to persons skilled in the art.

In a preferred embodiment of the present disclosure, the plug-in associated with RAWS 126 receives the user's request and queries LDAP database 118 as to whether the requested stream is protected, i.e., whether access to the requested content is limited to registered users. If the content is not protected, i.e., not restricted to access by registered users, the user will be given access without further clearance. The access parameters associated with content to be provided by RAMS (redundant array of media servers) 128 according to the present disclosure is stored within LDAP database 118.

If the requested content is limited in its availability to registered users (members), LDAP database 118 so instructs the plug-in associated with RAWS 126. In such case, RAWS 126 requests the user to provide appropriate registration/membership information, e.g., user name and password. Inasmuch as the sign-up wizard has previously established the creditworthiness of the registrant/member from credit bureau 110, a further check as to creditworthiness is generally unnecessary.

The user enters his/her user name/password, etc., and forwards the information to RAWS 126 and its associated plug-in. The user name/password, etc. are passed through to LDAP database 118 for evaluation/verification. In particular, LDAP database 118 is requested to provide the user's entered registration information. In response, LDAP database 118 returns the user's current registration information (if any) to the plug-in. Thus, PPV subsystem 108 advantageously authenticates a user prior to providing access to restricted content.

According to preferred embodiments of the present disclosure, the plug-in associated with RAWS 126 additionally initiates a query as to whether the user is already viewing a stream from RAMS 128. This inquiry is essential to ascertaining whether the user name/password may have been compromised and/or whether the user may be attempting to misuse his/her registration by allowing multiple individuals to view content based on a single registration. The PPV subsystem 108 disclosed herein collects and retains information as to users currently viewing/receiving content from RAMS 128 and is therefore able to ascertain the status of a user within PPV subsystem 108 in real time. If the user is already receiving/viewing content from RAMS 128, the user is denied access to the newly requested content by PPV subsystem 108.

Conversely, if the user's account is not currently viewing/receiving content, the plug-in verifies that the password is correct and that the registrant is part of a group having clearance/access to the requested content. For example, content may be tiered and premiere content may only be available to certain registrants. Additional parameters may be used to differentiate available content for a specific user, e.g., age appropriateness, predetermined content restrictions, etc. If the individual requesting the content is part of the group entitled to access the requested content, the plug-in associated with RAWS 126 instructs LDAP database 118 that the user is about to begin viewing the requested content, and informs the user that he/she has been authorized to receive the requested content. Streaming of the content from RAMS 128 generally begins immediately thereafter.

When the user discontinues receiving/viewing the requested content, i.e., the stream has ceased or the user has disconnected, the user's status is communicated from RAWS 128 through the plug-in associated with RAWS 126 to LDAP database 118 so that the user's account status can be updated to reflect that he/she is no longer receiving content. In this way, the PPV subsystem disclosed herein ensures that “one ticket, one seat” is achieved.

Although the system/method of the present disclosure has been described in detail with respect to certain preferred embodiments thereof, the present disclosure is not to be limited to such preferred embodiments. Rather, the advantages and enhanced functionality associated with the disclosed system/method are believed to have broad applicability, as will be apparent to persons skilled in the art from the detailed description provided herein and the claims that follow. Alternative uses and applications of the disclosed system/method are to be deemed within the spirit and scope of the present disclosure, and to be encompassed within the scope of the claims set forth herein.

What is claimed is:

1. A computer-based system for recording registration information related to a user, comprising:
a. a commerce server in communication with a source of registration information, said commerce server electronically providing a registration form for completion by a user;
b. at least one database in communication with said commerce server, said at least one database adapted to receive and store registration information transmitted by said commerce server;
wherein said commerce server transmits registration information to said at least one database for storage therein only upon completion of said registration form by said user.

2. A computer-based system according to claim 1, wherein said commerce server is included in a redundant array of commerce servers.

3. A computer-based system according to claim 1, wherein said registration information includes data selected from the group consisting of user name, password, mailing address, e-mail address, media player, media format and combinations thereof.

4. A computer-based system according to claim 1, wherein said registration information includes information related to a mode of payment.

5. A computer-based system according to claim 5, wherein said commerce server is in electronic communication with a credit bureau, and said information related to a mode of payment is automatically transmitted to said credit bureau upon receipt from a user.

6. A computer-based system according to claim 1, wherein said at least one database is a commerce database.

7. A computer-based system according to claim 1, further comprising an LDAP database, and wherein said registration information is transmitted to said LDAP database for storage therein.

8. A computer-based system according to claim 7, further comprising an SQL database, and wherein said registration information is transmitted to said SQL database for storage therein.

9. A computer-based system according to claim 1, wherein registration information transmitted by said commerce server to said at least one database is exclusively cached in the RAM of an LDAP database.

10. A computer-based system for controlling access to restricted content, comprising:
a. at least one web server in network communication with at least one potential user of said restricted content;
b. at least one database in communication with said at least one web server, said at least one database containing registration information that controls a potential user's access to said restricted information;
c. at least one media server in communication with said at least one web server for delivering restricted content to a potential user;
wherein said at least one web server automatically queries said at least one database to determine a potential user's access to said restricted content upon receipt of a request from said potential user; and
wherein said at least one web server automatically queries said at least one database to determine whether said at least one media server is currently delivering restricted content to said potential user.

11. A computer-based system according to claim 10, wherein said at least one web server is included in a redundant array of web servers.

12. A computer-based system according to claim 10, wherein said at least one database is an LDAP database.

13. A computer-based system according to claim 12, further comprising a commerce database and an SQL database.

14. A computer-based system according to claim 12, wherein said registration information in stored exclusively in RAM of said LDAP database.

15. A computer-based system according to claim 10, further comprising at least one commerce server, and wherein said registration information is supplied by a potential user to said commerce server.

16. A computer-based system according to claim 10, wherein said at least one web server prevents said potential user from accessing said restricted content if said potential user is currently receiving restricted content from said at least one media server.

17. A computer-based method for registering a potential user and controlling access to restricted content, comprising:
a. communicating a registration form to said potential user across a computer network;
b. receiving registration information related to said registration form from said potential user and storing said registration information in a database only after said registration form is completed by said potential user;
c. receiving a request for access to restricted content from said potential user; and
d. verifying said potential user's access to said restricted content before transmitting said restricted content to said potential user.

18. A method according to claim 17, wherein said verification of said potential user's access includes determining whether said potential user is currently receiving restricted content.

19. A method according to claim 17, further comprising delivering restricted content to said potential user based on said verification.

20. A method according to claim 17, further comprising automatically verifying a proposed payment mode provided by said potential user in connection with receiving said registration information from said potential user.
